(19) United States
(12) Patent Application Publication
(10) Pub. No.: US 2025/0050823 A1
(43) Pub. Date: Feb. 13, 2025

(54) COVER ELEMENT FOR A CENTER CONSOLE

(71) Applicant: Novem Car Interior Design GmbH, Vorbach (DE)

(72) Inventors: Andreas Birkner, Windischeschenbach (DE); Tobias Bauer, Haag (DE)

(21) Appl. No.: 18/777,412

(22) Filed: Jul. 18, 2024

(30) Foreign Application Priority Data
Jul. 19, 2023 (DE) 102023119132.2

(51) Int. Cl. B60R 13/02

(52) U.S. Cl. CPC B60R 13/0262

(57) ABSTRACT

The invention relates to a cover element for a center console, comprising a decorative element for providing the surface decoration, and a soft component, wherein the soft component is designed to be flexible in order to avoid damage to adjacent components, for example the instrument panel, when installing and/or removing the cover element into and/or from the motor vehicle interior, and wherein the soft component is provided in the installed state of the cover element to reduce the gap size relative to adjacent components, for example the instrument panel.

### CROSS-REFERENCE TO RELATED APPLICATIONS

The present invention claims priority to German 10 2023 119 132.2, filed on Jul. 19, 2023. The entire content of each of the aforementioned patent applications is incorporated herein by reference.

### BACKGROUND OF THE INVENTION

### 1. Field of the Invention

The invention relates to a cover element for a center console.

### 2. The Relevant Technology

A “center console” is understood in particular to be the part of the dashboard in an automobile that begins at approximately knee height between the two front footwells and extends to the position of the backrest between the front seats. This region often includes the selector lever, which in many vehicles is located between the front driver and passenger seats. The center console can also include an armrest for the driver and front passenger. The center console can also be used for comfort, control and display elements (ventilation/air conditioning, car radio, navigation system). Furthermore, the selector lever can be arranged on or in the region of the center console. The center console often also has smaller storage compartments, cup holders and cigarette lighters.

The center console is usually installed on the dashboard with the instrument panel. Due to various installation curves and tolerances, a necessary intentional gap arises between the center console and the instrument panel, which on the one hand allows a view underneath the instrument panel and, on the other hand, offers the possibility that objects can get lost in the gap, which in turn can lead to noise. This also cannot prevent the vehicle occupants from unintentionally “reaching in,” which can lead to potential injuries.

In the motor vehicle interior, with respect to cover elements, surfaces without recesses, such as compartments or trays for objects, are increasingly in demand. Objects placed on such surfaces, such as mobile devices, can slip or even flung through the intentional gap under the instrument panel, for example when braking. This is possible during heavy braking even despite anti-slip structures.

### BRIEF SUMMARY OF THE INVENTION

The object of the invention is to provide a new cover element for a center console, in particular a cover element, which closes the intentional gap between the center console and the instrument panel at least substantially, in particular in all three spatial directions (x, y and z directions).

This object is achieved by a cover element having the features of claim 1. Advantageous embodiments and further developments are provided in the dependent claims.

The cover element according to the invention comprises a decorative element for providing the surface decoration, and a soft component, wherein the soft component is designed to be flexible in order to avoid damage to adjacent components, for example the instrument panel, when installing and/or removing the cover element into and/or from the motor vehicle interior, and wherein the soft component is provided when the cover element is in the installed state to reduce the gap size relative to adjacent components, for example the instrument panel.

The soft component is designed and/or provided in particular as a visual and/or noise barrier.

The advantages of the invention lie in particular in the fact that there is no longer any visibility between the instrument panel and the center console. Narrow objects such as maps can no longer get “lost” between the center console and the instrument panel without exerting force. Furthermore, the interface between the instrument panel and center console is acoustically decoupled. Another advantage is that the cover element in the region of the instrument panel is easily to installed afterwards since there are no rigid parts that can break.

The decorative element can, for example, have a bowl-shaped form. It can be provided that the decorative element has a recess, in particular a U-shaped recess. The recess extends, for example, from an edge of the decorative element into the decorative element.

Preferably, the soft component is arranged on, in particular attached to, the decorative element. The decorative element can have ribs, in particular on its underside opposite the surface decoration, and the soft component can have openings corresponding to the ribs, wherein the soft component is attached to the decorative element by means of the ribs inserted into the openings.

Preferably, the decorative element has at least two, preferably four, ribs. In particular, the soft component has a number of openings corresponding to the number of ribs.

Preferably, the cover element comprises one or more, preferably two, finishing strips, for example made of chrome or plastic. The finishing strips are preferably arranged laterally on the decorative element. In particular, the finishing strips are placed on or attached to the decorative element and preferably welded to the decorative element, in particular by means of a hot caulking system.

The cover element can comprise one or more light elements, wherein the light element(s) is/are arranged in particular in the finishing strip(s) or in the region of the finishing strip or strips.

It can be provided that the cover element comprises a finishing frame, for example made of chrome or plastic, wherein the finishing frame is preferably arranged on the edge of the recess of the decorative element.

The finishing frame can be U-shaped, in particular to cover the edge of the recess of the decorative element. In particular, the finishing frame is placed on or attached to the decorative element and preferably welded to the decorative element, in particular by means of a hot caulking system.

Furthermore, it can be provided that the cover element comprises a base support, wherein the decorative element and/or the soft component are arranged on the base support, in particular are attached to the base support.

The soft component can be attached to the base support by means of, for example, five hooks, in particular to prevent movement in the longitudinal direction.

Preferably, the finishing strips and/or the finishing frame are arranged on the base support.

It can be provided that the decorative element and/or the soft component, in particular together with the finishing strips and/or the finishing frame, are welded to the base support.

Particularly preferably, the soft component is formed from a flexible and/or deformable plastic, in particular a styrene-based thermoplastic elastomer.

The material of the soft component can correspond visually with the material of the decorative element, preferably by means of a film applied to the soft component and/or adapted to the surface decoration. If the decorative element is a wood veneer, for example, a film with a wood veneer look is applied to the soft component. In addition to foiling, other methods are also possible. The prerequisite for the adjustment of the look is in particular that the flexibility of the soft component is not or at least largely not impaired.

It can be provided that the decorative element for providing the surface decoration has a decorative layer with a front side designed as a visible side and a back side opposite the front side, wherein the decorative layer is, for example, a wood veneer.

Furthermore, it can be provided that a support, in particular a plastic support, is arranged on the back side of the decorative layer, wherein an adhesive layer and/or a nonwoven is preferably arranged between the decorative layer and the support.

It can also be provided that a protective and/or optical layer is arranged on the front side of the decorative layer, wherein the protective and/or optical layer is in particular a varnish or comprises a varnish.

For example, the cover element comprises one or more attached parts, for example light elements, in particular LEDs, and/or light guides and/or fastening elements, in particular clamps.

It can be provided that the cover element, in particular in the region of the surface of the cover element, comprises one or more anti-slip elements, for example recesses and/or elevations such as knobs, so that in particular one or more objects can be placed primarily slip-free on the cover element.

### BRIEF DESCRIPTION OF THE DRAWINGS

The invention is explained in more detail below also with regard to further features and advantages on the basis of the description of exemplary embodiments and with reference to the accompanying schematic drawing. In the drawings:

FIG. 1 shows an embodiment of the cover element according to the invention in a three-dimensional representation with a view from above;

FIG. 2 shows a detail of the cover element according to FIG. 1 viewed from below;

FIG. 3 shows a detail of the cover element according to FIG. 1 viewed toward the back,

FIG. 4 shows the cover element according to FIG. 1 viewed toward the back,

FIG. 5 shows the cover element according to FIG. 1 in installed condition, viewed from the side,

FIG. 6 shows the cover element according to FIG. 1 in the installed condition, viewed from above.

### DETAILED DESCRIPTION

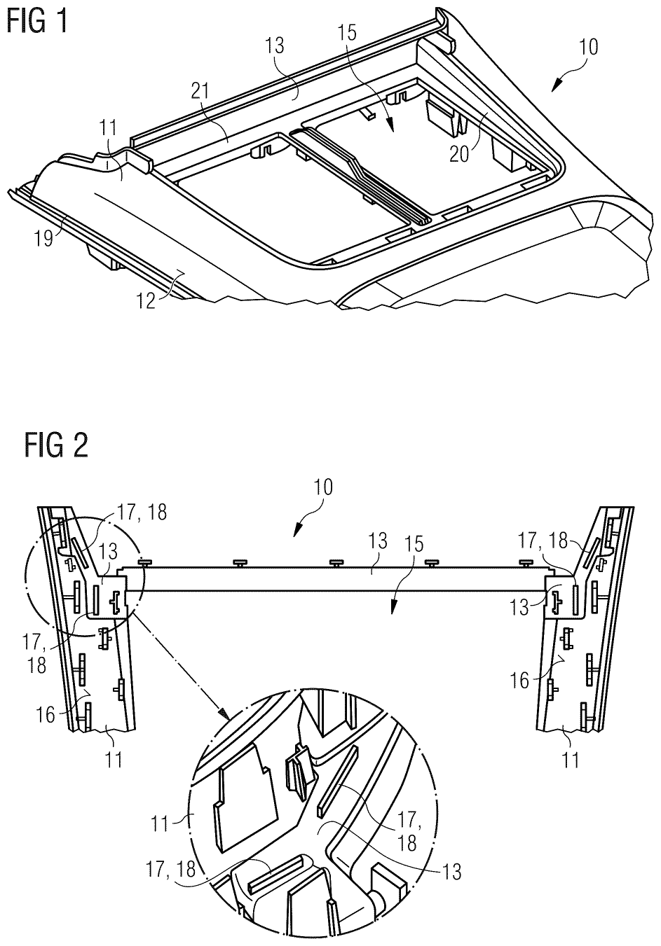

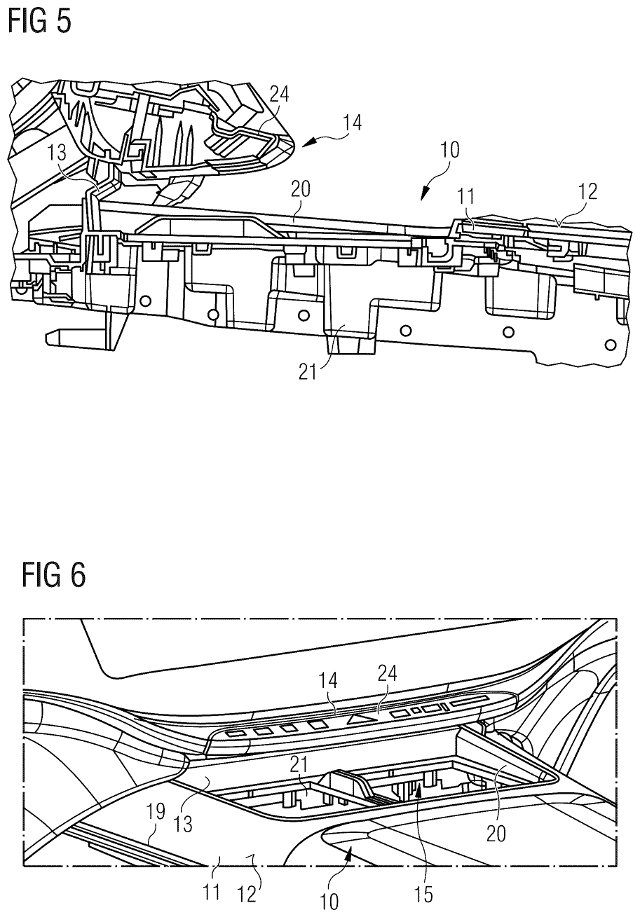

FIG. 1 shows a cover element 10 according to the invention for a center console. The cover element 10 comprises a decorative element 11 for providing the surface decoration 12 and a soft component 13. The soft component 13 is designed to be flexible in order to avoid damage to adjacent components, such as the instrument panel 14, when installing the cover element 10 in the motor vehicle interior or when removing the cover element 10 from the motor vehicle interior. A rigid part at this position which is made of, for example, wood or plastic, could lead to material breakage. FIG. 5 and FIG. 6 show the installed state. The soft component 13 is made of a flexible and/or deformable plastic, in particular a styrene-based thermoplastic elastomer. The soft component 13 can be visually adapted to the decorative element 11. Due to the flexibility or deformability of the soft component 13, the occurrence of damage to the instrument panel 14, in particular the switch unit 24 of the instrument panel 14, during installation of the cover element 10 is avoided, because the flexibility allows crumpling of the soft component 13 in the event of a collision with the instrument panel 14 without causing damage. The material of the soft component 13 is also in particular stiff enough to prevent the soft component 13 from sagging. In the installed state, the soft component 13 is preferably collision-free again with respect to the instrument panel 14, i.e., not deformed.

When the cover element 10 shown in FIG. 5 and FIG. 6 is in the installed state, the soft component 13 is also provided for reducing the gap size relative to the adjacent instrument panel 14. In the installed state, the soft component 13 thus forms a visual and/or noise barrier, as shown in FIG. 6. In the installed state, the soft component 13 makes it impossible to see under the instrument panel 14. In addition, no objects can undesirably slip or fall under the instrument panel 14. Reaching under the instrument panel 14 by a motor vehicle occupant is also prevented.

The soft component 13 is arranged on the decorative element 11. As can be seen in FIG. 2, the decorative element 11 has four ribs 17 on its underside 16 opposite the surface decoration 12, and the soft component 13 has four openings 18 corresponding to the ribs 17, wherein the soft component 13 is attached to the decorative element 11 by means of the ribs 17 inserted into the openings 18.

The cover element 10 further comprises two finishing strips 19 shown, for example, in FIG. 1, made of chrome that are arranged laterally on the decorative element 11. In particular, the finishing strips 19 are placed on or attached to the decorative element 11 and welded to the decorative element 11 by means of a hot caulking system.

FIG. 1, FIG. 2, FIG. 4 and FIG. 6 show that the decorative element 11 has a U-shaped recess 15. The recess 15 extends from an edge side of the decorative element 11 into the decorative element 11. The cover element 10 further comprises a finishing frame 20 made of chrome that is arranged on the edge of the recess 15 of the decorative element 11. The finishing frame 20 is U-shaped in order to cover the edge of the recess 15 of the decorative element 11. In particular, the finishing frame 20 is placed on or attached to the decorative element 11 and welded to the decorative element 11 by means of a hot caulking system.

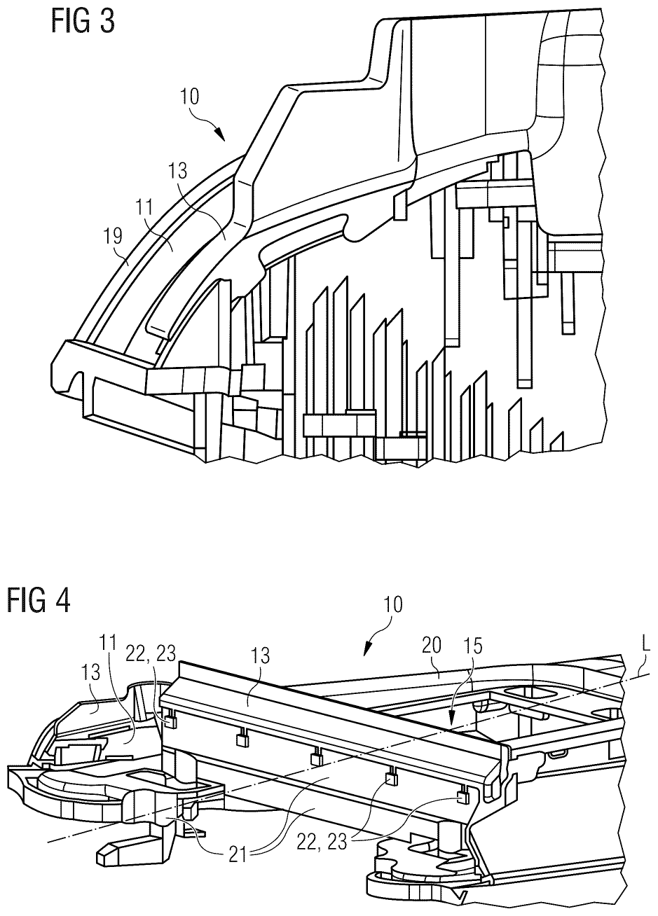

The cover element 10 further comprises a base support 21, wherein the decorative element 11 and the soft component 13 are arranged on the base support 21 by the decorative element 11 and the soft component 13, together with the finishing strips 19 and the finishing frame 20, being welded to the base support 21 by sandwich welding, as shown in particular in FIG. 3. The soft component 13 is, as shown in FIG. 4, additionally fastened to the base support 21 by means of five hooks 22 in order to avoid movement in the longitudinal direction L, wherein the hooks are arranged on the soft component 13 and are hooked into corresponding openings 23 in the base support 21. Furthermore, the finishing strips 19 and the finishing frame 20 are arranged on the base support 21.

The decorative element 11 has a decorative layer for providing the surface decoration, wherein the decorative layer has a front side designed as a visible side and a back side opposite the front side. The decorative layer is, for example, a wood veneer, metal, stone, carbon, or a film composite. A support, in particular a plastic support, is arranged on the back side of the decorative layer, wherein an adhesive layer and a nonwoven can be arranged between the decorative layer and the support. Furthermore, it can be provided that a protective and/or optical layer is arranged on the front side of the decorative layer, wherein the protective and/or optical layer is in particular a varnish.

The cover element 10 can comprise further attached parts (not shown in the figures), for example lighting elements such as LEDs, light guides or fastening elements such as clamps.

### LIST OF REFERENCE SIGNS

10 Cover element
11 Decorative element
12 Surface decoration
13 Soft component
14 Instrument panel
15 Recess
16 Underside
17 Rib
18 Opening
19 Finishing strip
20 Finishing frame
21 Base support
22 Hook
23 Opening
24 Switch unit
L Longitudinal direction

1-13. (canceled)

14. A cover element for a center console, comprising:
a decorative element for providing the surface decoration, and
a soft component, wherein the soft component is designed to be flexible in order to avoid damage to adjacent components when installing and/or removing the cover element into and/or from the motor vehicle interior, and wherein the soft component is provided in the installed state of the cover element to reduce the gap size relative to adjacent components.

15. The cover element according to claim 14, wherein:
the soft component is arranged on the decorative element.

16. The cover element according to claim 15, wherein:
the decorative element has ribs, and the soft component has openings corresponding to the ribs, wherein the soft component is attached to the decorative element by means of the ribs inserted into the openings.

17. The cover element according to claim 14, wherein:
the cover element comprises one or more finishing strips.

18. The cover element according to claim 14, wherein:
the cover element comprises one or more light elements.

19. The cover element according to claim 14, wherein:
the cover element comprises a finishing frame.

20. The cover element according to claim 14, wherein:
the cover element comprises a base support, wherein the decorative element and/or the soft component are arranged on the base support.

21. The cover element according to claim 14, wherein:
the soft component is made of a flexible and deformable plastic.

22. The cover element according to claim 14, wherein:
the material of the soft component visually corresponds to the material of the decorative element.

23. The cover element according to claim 14, wherein:
the decorative element has a decorative layer for providing the surface decoration with a front side designed as a visible side and a back side opposite the front side.

24. The cover element according to claim 23, wherein:
a support is arranged on the back of the decorative layer.

25. The cover element according to claim 14, wherein:
the cover element comprises one or more attached parts.

26. The cover element according to claim 14, wherein:
the cover element comprises one or more anti-slip elements.
